(19) United States
(12) Patent Application Publication
(10) Pub. No.: US 2012/0315566 A1
(43) Pub. Date: Dec. 13, 2012

(54) ELECTRICAL ENERGY UNIT AND SPACER

(75) Inventors: Tim Schaefer, Harztor (DE); Claus-Rupert Hohenthanner, Hanau (DE)

(73) Assignee: Li-Tec Battery GmbH, Kamenz (DE)

(21) Appl. No.: 13/522,451

(22) PCT Filed: Dec. 21, 2010
(86) PCT No.: PCT/EP2010/007844

§ 371 Date: Jul. 19, 2012

(30) Foreign Application Priority Data
Jan. 19, 2010 (DE) 10 2010 005 017.2

(51) Int. Cl. H01M 2/10; H01M 2/14; H01G 9/025; H01M 8/24

(52) U.S. Cl. 429/468; 429/99; 429/508; 429/129; 429/144; 361/523

(57) ABSTRACT

The invention relates to an electrical energy unit (2, 102, 202, 302) comprising a plurality of electrical energy cells (4), which are stacked in a stacking direction to form a cell block and are connected to each other in parallel and/or in series within the cell block, the electrical energy cells having planar conductors (14), which protrude from the cell substantially in parallel with each other in two directions, the main surfaces of the conductors being oriented substantially perpendicularly to the stacking direction, the conductors of a cell at least partially not covering each other, as viewed in the stacking direction, and each conductor of a cell at least partially covering a conductor of a subsequent cell in the stacking direction, as viewed in the stacking direction. The electrical energy unit is characterized in that the electrical connection between opposite conductors is produced by spacers that do or do not establish contact therebetween, the spacers (20, 120, 220, 520, 620) being arranged in intermediate spaces between conductors of consecutive cells, the spacers being clamped between the conductors by a compressive force by means of a clamping device (10, 506, 508, 524, 526), the clamping device being arranged completely outside the conductors. The invention further relates to spacers for use between conductors of consecutive cells in such an electrical energy unit.

The present invention relates to an electrical energy unit comprising a plurality of electrical energy cells stacked to form a block and a spacer for use between the electrical current connectors of the electrical energy cells.

Assembling electrical energy units from electrical energy cells stacked to form a block is known, as for instance batteries from galvanic primary cells, accumulators from galvanic secondary cells, capacitors and fuel cells stacked and grouped into modules.

Batteries (primary storage) and accumulators (secondary storage) for storing electrical energy assembled from one or more storage cells are particularly known in which when a charging current is applied, an electrochemical charging reaction between a cathode and an anode in or between an electrolyte coverts electrical energy into chemical energy and thus stores it, and in which when an electrical load is applied, an electrochemical discharging reaction converts chemical energy into electrical energy. In this process, primary storages are usually only charged once and are to be disposed of after they have been discharged whereas secondary storages allow multiple charge/discharge cycles (from a few hundred to more than 10,000). It is hereby to be noted that accumulators are also sometimes called batteries such as e.g. motor vehicle batteries which are known to experience frequent charge cycles.

In recent years, lithium compound-based primary and secondary storages have become increasingly important. They have a high energy density and thermal stability, supply a constant voltage at a low self-discharge, and have no so-called memory effect.

Manufacturing energy stores and in particular lithium batteries and accumulators in the form of thin plates is known. For details on the operating principle of a lithium-ion cell, reference is made by way of example to Dr. K. C. Möller and Dr. M. Winter, “Primary and Rechargeable Lithium Batteries and Accumulators,” Institute of Inorganic Chemical Technology, Graz University of Technology, February 2005.

In order to obtain the desired voltages and capacities in practice, for example in motor vehicle or other vehicle batteries, it is necessary to arrange a plurality of cells into a stack and interconnect their connectors in a suitable way. The interconnecting of the individual cells usually occurs on a narrow side of the cells (usually defined as “upper”) from which the connectors protrude. Such interconnected assemblies are known from WO 2008/128764 A1, WO 2008/128769 A1, WO 2008/128770 A1 and WO 2008/128771 A1.

A similar arrangement is known from JP 07-282841 A in which the individual cells are assembled into a housing. The individual cells here are situated loosely in individual partitions of a housing and the upward-projecting contacts are connected together by bolts. The entire arrangement is then closed from the top by a cover.

Combining a plurality of thin, cuboid galvanic cells into one or more stacks in such a way that their largest dimensioned (flat) sides are facing or contacting one another and then cast as such in a retaining device is known from a not yet published development.

The inventors are also aware of a printed not otherwise documented arrangement in which a plurality of flat cells are stacked between two pressure plates, whereby the stack is held together by tension rods (threaded bolts or cheese head screws) extending between the pressure plates.

It is an object of the present invention to devise an electrical energy unit from a plurality of electrical energy cells with improved block formation and cell contact.

The object is solved by the features of the independent claims. Advantageous further developments of the invention constitute the subject matter of the subclaims.

An electrical energy unit according to a first aspect of the invention comprises a plurality of electrical energy cells which are stacked in a stacking direction to form a cell block and are connected to each other in parallel and/or in series within the cell block, wherein the electrical energy cells comprises planar connectors protruding from the cell with substantially parallel surfaces to one another, wherein the main surfaces of the connectors are oriented substantially perpendicular to the stacking direction, wherein the connectors of a cell do not cover each another at least partly as viewed in the stacking direction, wherein each connector of a cell at least partly covers a respective connector of a subsequent cell in the stacking direction as viewed in said stacking direction. The invention is characterized in that the electrical connection between opposite connectors is produced by through-connecting spacers or non-through-connecting spacers disposed in the interspaces between connectors of consecutive cells, wherein the spacers are clamped between the connectors by a compressive force from a clamping device, wherein the clamping device is arranged completely externally of the connectors.

To be understood by an electrical energy unit in the context of the invention is a component which is also able to emit electrical energy. To be understood by an electrical energy cell in the context of the invention is a structurally self-contained cell which is also able to emit electrical energy. It can thereby be a galvanic primary cell which only dispenses its stored energy once, a galvanic secondary cell which can be charged and discharged a plurality of times, a fuel cell, a capacitor cell or the like. It can in particular be a galvanic secondary cell, whereby at least one of the cell's electromagnetically active material comprises lithium or a lithium compound. A suitable electrical interconnection forms the electrical energy cells into an electrical energy unit. To be understood by a connector in the context of the invention is an externally-accessible connection which is connected to the electrochemically active members within the galvanic cell and also serves as a pole of the cell. To be understood by a planar body in the context of the invention is a body exhibiting two parallel main surfaces with its expansion in two spatial directions of a body-oriented Cartesian coordinate system parallel to the main surfaces being substantially larger than in the third spatial direction; the third spatial direction thereby being defined as the body's thickness direction. To be understood by a spacer in the sense of the invention is a component which has an expansion in the stacking direction of the battery which corresponds to the space between two conductors of consecutive storage cells. A spacer should lightly contact both connectors, be easily dispaceable between same, and be clamped between same upon external surface-normal pressure on the connectors. To be understood by through-connecting in the sense of the invention is the establishing of an electrical connection between opposite connectors.

An electrical energy unit according to this aspect of the invention has the advantage that the spacer only needs to be loosely positioned between the connectors and just one clamping process is needed to secure it between said connectors. It is not necessary, for example, to secure individual connecting elements between the connectors. The spacers can also be removed and replaced when the clamping device is released without needing to dismantle the entire cell block. Conversely, given a suitable spacer design and securing, individual cells can be removed and replaced without needing to dismantle the entire cell block.

The electrical energy unit can be further characterized in that the clamping device comprises force-generating elements to generate a force, wherein the force-generating elements act directly on the arrangement of connectors and spacers in the stacking direction.

The electrical energy unit can be further characterized in that the clamping device comprises force-generating elements to generate a force and force-transmitting elements, wherein the force-transmitting elements transmit the force exerted on the arrangement of connectors and spacers by the force-generating elements.

The electrical energy unit can be further characterized in that the clamping device comprises tension rods which extend past the connectors over the length of the stack and clamping elements, wherein the clamping elements transmit a force exerted by the tension rods to a plane traversing the spacers.

Such an electrical energy unit can be configured such that the tension rods run through bores in the spacers.

The electrical energy unit can be further characterized in that the clamping device comprises at least one actuator, whereby an external actuating force of the actuator acts on the arrangement of connectors and spacers in the stacking direction either directly or via levers, joints or the like.

Such an electrical energy unit can be configured such that the actuator can be controlled mechanically, particularly manually, or else electromotively, electromagnetically, hydraulically, pneumatically or piezoelectrically.

The electrical energy unit can be further characterized in that a spacer abutting a connector exhibits a tapping device which establishes an electrical connection with the connector.

Such an electrical energy unit can be configured such that the tapping device is provided on a unilaterally contacting spacer which is a non-through-connecting spacer. To be understood by a unilaterally contacting spacer in the sense of the invention is a spacer which establishes an electrical connection to only one single side of the spacer. Such a unilaterally contacting spacer can be disposed respectively at the first and the last connector (pole) of a series connection of storage cells in order to tap the pole voltage (the nominal potential) of the serial connection. Such a unilaterally contacting spacer, which is a non-through-connecting spacer, can also be used to connect in parallel two groups of cells interconnected in series within a cell block. If the tapping device is conversely provided on a through-connecting spacer, intermediate potentials can be tapped within the cell block.

The electrical energy unit can be further characterized in that a first connecting pole and a second connecting pole of the electrical energy unit are provided, wherein the first connecting pole is connected to a connector of a first polarity of the first cell in the cell block, and wherein the second connecting pole is connected to a connector of a second polarity of the last cell in the cell block. To be understood by a connecting pole in the sense of the invention is a contact which is also contactable from outside of the electrical energy unit so that an electrical connection can be established.

Such an electrical energy unit can be configured such that the cells are arranged in the stacking direction with alternating pole directions. Doing so thus makes it particularly simple to realize a serial connection of the cells with conductive and non-conductive spacers by simply alternatingly arranging them between consecutive connectors. Parallel connections are also simple to realize as described above in connection with unilaterally contacting spacers. Parallel connections can also be realized by like cell pole directions in which the respectively same poles can be connected by means of through-connecting spacers. Series connections of respective groups of multiple connected cells can be realized by respectively arranging the cells of consecutive groups having differing pole directions with a through-connecting and a non-through-connecting spacer being inserted between the last cell of one group and the first cell of the next group.

Such an electrical energy unit can be configured such that the cell block of the plurality of cells is clamped between two pressure plates, whereby the pressure plates are tensioned, preferably by means of tension rods. Doing so thus allow the cells to be simply and reliably grouped and secured.

The electrical energy unit can be further characterized in that the electrical energy cells are galvanic cells, preferably secondary cells, whereby an electromagnetically active material of the cells in particular comprises lithium or a lithium compound.

A further aspect of the invention proposes using a spacer between connectors of two consecutive electrical energy cells in a cell stack, wherein the spacer is made from an electrically non-conductive material and exhibits two parallel end faces at a distance of the interspace between the connectors, at least one first receiving device for receiving a contact element for the electrical contact on at least one of the end faces, and a second receiving device for receiving a connecting element to establish an electrical connection with the contact element of another face of the spacer other than the end face.

To be understood by a contact element in the sense of the invention is any mechanism or structural design or any section of a component which is designed and equipped to establish an electrical contact with a face opposite an end face of the spacer. To be understood by a receiving device in the sense of the invention is any mechanism or structural design which is designed and equipped to receive a contact element.

A further aspect of the invention proposes using a spacer between connectors of two consecutive electrical energy cells in a cell stack, wherein the spacer exhibits a center section made of an electrically non-conductive material as well as two outer sections made from an electrically conductive material bordering the center section in a parallel, sandwiching manner, wherein the outer sections define the spacer end faces, wherein the distance between the end faces corresponds to the distance of an interspace between connectors of two consecutive electrical energy cells in the cell stack, wherein at least two recesses are provided in other external surface areas than the two end faces, wherein one of said recesses exhibits a connection to one of the outer sections but no connection to the other of the outer sections, and wherein the other recesses exhibit a connection to the other of the outer sections but no connection to said one of the outer sections, wherein the recesses are configured elsewhere than the end faces.

To be understood by a recess in the sense of the invention is a bore, cavity or other configuration integrated into the spacer from a surface (a different surface than the end faces).

Such a spacer can abut the connectors of consecutive storage cells by its end faces defined by the outer sections. Since the outer sections are electrically insulated from one another by the non-conductive center section, there is no connection between the conductors. Bridging the recesses can, however, create an electrically conductive connection between the outer sections so as to establish a through-connection between the conductors. On the other hand, a connection to one of the outer sections can be established through one of the recesses and thus the potential of the neighboring current tapped.

More than two such recesses can be provided.

The features, functions and advantages of the present invention as cited in the claims as well as others will become clearer from the following description of preferred embodiments which make reference to the accompanying drawings.

### THE DRAWINGS SHOW

FIG. 1 a partly sectional plan view of a battery as a first embodiment of the invention;

FIG. 2 a cross-sectional view of the battery from FIG. 1 along the II-II line in FIG. 1 between two battery cells in the viewing direction of the associated arrows;

FIG. 3 a longitudinal sectional view of the FIG. 1 battery along the III-III line in FIG. 1 at the level of a series of connectors and spacers in the viewing direction of the associated arrows;

FIG. 4 an enlarged depiction of a spacer from FIG. 3 without fitted components in a cross-sectional view through a central plane along the IV-IV line in FIG. 3 in the viewing direction of the associated arrows;

FIG. 5 a side view of the spacer from FIG. 4 in the viewing direction of the V arrow from FIG. 4;

FIG. 6 a horizontal cross-sectional view of the spacer from FIG. 4 with fitted components in a unilaterally contacting configuration sectioned at the level of transverse and axial bores along the VI-VI line in FIG. 4 in the viewing direction of the associated arrows;

FIGS. 7-8 depictions of a spacer with fitted components in a unilaterally contacting configuration as a second embodiment of the invention in a partly cross-sectional view and a longitudinal sectional view;

FIGS. 9-10 depictions of the spacer from FIGS. 7 and 8 with fitted components in a unilaterally contacting configuration;

FIGS. 11-13 depictions of a spacer with fitted components in a unilaterally contacting configuration as a third embodiment of the invention in a partly cross-sectional view, a longitudinal sectional and a plan view;

FIGS. 14− 15 depictions of the spacer from FIGS. 7 and 8 with fitted components in a unilaterally contacting configuration;

FIG. 16 an enlarged, partly exploded depiction of detail XVI from FIG. 3 of a battery in a fourth embodiment of the present invention having a pressure bolt as a pressure element;

FIG. 17 a partly exploded depiction of a detail corresponding to FIG. 16 of a battery in a fifth embodiment of the present invention having a pressure cell as a pressure element;

FIG. 18 a depiction of a detail corresponding to FIG. 16 of a battery in assembled configuration in a sixth embodiment of the present invention having tension rods as a pressure element;

FIG. 19 a sectional plan view of the detail from FIG. 18 along the FIG. 18 XIX-XIX line in the viewing direction of the associated arrows;

FIGS. 20-21 depictions of the sectional progression of the FIGS. 2 and 3 battery corresponding to the embodiment from FIGS. 18 and 19;

FIG. 22 a horizontal sectional view of a spacer in a seventh embodiment of the invention;

FIG. 23 a side view of the spacer from FIG. 22;

FIGS. 24-25 side views of a modified spacer of the embodiment according to FIG. 23;

FIG. 26 a plan view of an end piece in an eighth embodiment of the invention;

FIG. 27 a longitudinal sectional view of the end piece from FIG. 26 along the XXVII-XXVII line in FIG. 26 in the viewing direction of the associated arrows; and

FIG. 28 a view of the end piece from FIG. 27 in activated state.

It is to be pointed out that the depictions in the figures are schematic and are limited to reproducing the features most important to understanding the invention. It is also pointed out that the dimensions and proportions shown in the figures are solely for the purpose of providing illustrative clarity and are in no way to be considered limiting or excluding.

The following provides a precise description of concrete embodiments and conceivable modifications thereof based on the accompanying figures. Wherever identical components are used in different embodiments, they are identified by the same or analogous reference numerals. In the context of this description, components having reference numerals differing from one another by multiples of 100 have the same or similar functions. To a great extent, attempts have been made to avoid any repeated explanation in conjunction with embodiment features and their functions provided there are no different or further aspects due to specific features of the respective embodiment. Notwithstanding the above, unless explicitly or otherwise indicated or obviously technically infeasible, the features, configurations and effects of an embodiment and its modifications are also to be conferred on other embodiments and their modifications.

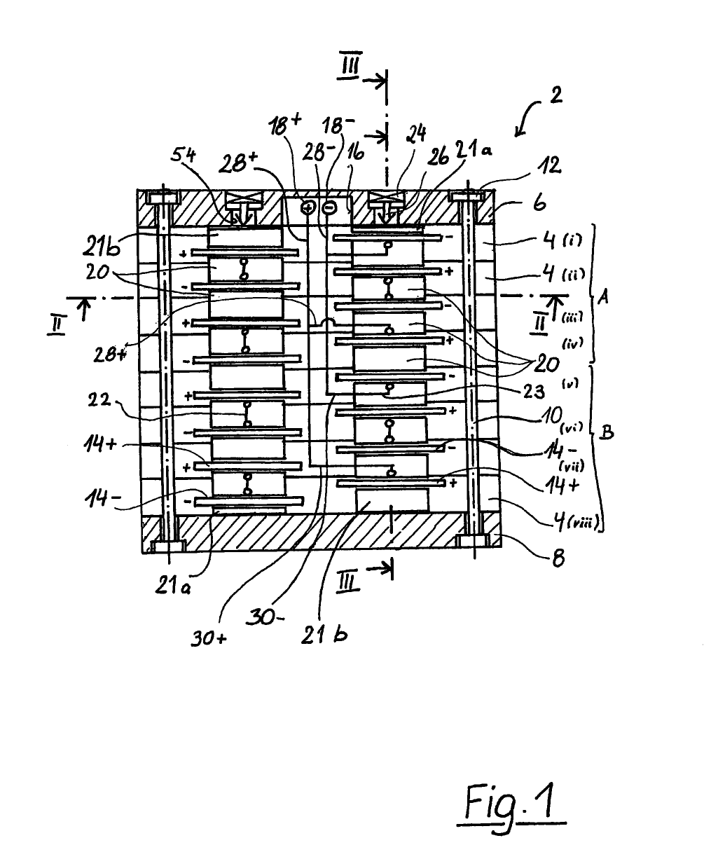

FIG. 1 schematically depicts a first primary embodiment of the present invention. FIG. 1 is a partly sectional plan view of a battery 2 having eight storage cells 4 stacked between two end pressure plates 6, 8 (front pressure plate 6, counter-pressure plate 8) and tensioned by means of tension rods 10 and nuts 12. The figure sections the pressure plates 6, 8 and their components but not, however, the components disposed between said pressure plates 6, 8. The position of the storage cells 4 within the stack is consecutively numbered (i) to (viii).

The tension rod 10 is also referred to as a block anchor 10, its function being clarified as clamping the storage cells 4 into a block. The nuts 12 for the tension rods 10 are mounted to be rotationally-secured but axially movable in corresponding recesses of the connector pressure plate 6. The nuts 12 are preferably square nuts or hexagonal nuts. (The pressure plates 6, 8 can exert pressure on the entire surface of the storage cells 4. They can alternatively only exert pressure on an edge region of the storage cells 4, which can be reinforced if needed, in order to keep the mechanically stressing of the internal parts of the storage cells 4 low or prevent it entirely.)

The storage cells 4 exhibit a flat, cuboid base body with two expanded planar sides or end faces (front and rear) and four narrow sides (right and left side, also called flanks, upper and lower side). The storage cells 4 lie atop one another on their respective planar front and rear sides and form a stack. The stacking direction of the storage cells 4 is also referred to in the context of the present invention as the axial direction of the battery 2.

In the present preferred embodiment, the storage cells 4 are lithium accumulator cells (in the context of the present application, accumulators; i.e. secondary storages, are also referred to as batteries). The base body of each storage cell 4 accommodates an active part in which an electrochemical reaction occurs to store and supply electrical energy (charge/discharge reaction). The internal structure of the active part not depicted in greater detail in the figure corresponds to a flat, laminated stack of electrochemically active electrode films of two types (cathode and anode), electrically conductive films for collecting and feeding or discharging electrical current to and from the electrochemically active areas, and separator films for separating the two types of electrochemically active areas from one another. At least one type of the electrochemically active electrode films comprises lithium or a lithium compound. Such a construction is well-known in technology and does not need to be elaborated on any further here. As background, reference is made to the Möller/Winter prior art cited in the introductory part of the description, its disclosure insofar wholly incorporated by reference.

Two connectors 14 (14+, 14−) protrude perpendicularly outward from each of cells 4 from a narrow side defined as the upper side. The connectors 14 are connected to the electrochemically active cathode and anode areas within the active area and thus serve as cathode and anode connections for cell 4. In particular, connector 14+ constitutes a positive pole for cell 4 and connector 14− constitutes a negative pole for cell 4. The connectors 14 are made from a good conductive material such as copper or aluminum. To improve the contact, a coating of e.g. silver of gold (sputtered, plated or the like) can be provided. The connectors 14 are flat structures, their width and height clearly greater than their thickness and their height clearly less than their width. They are arranged on the upper side of cell 4 with substantially parallel surfaces to one another and arranged offset both in the width direction as well as the thickness direction. The cross sections of the connectors 14 neither overlap in a frontal nor flank view and their projections exhibit a spacing from each other in each of these lines of sight. Connector 14 is disposed mirror-symmetrical with respect to each axis of symmetry of the upper side of cell 4.

The cells 4 are stacked with an alternating connector 14+, 14− pole direction. In other words, the first cell 4(i) is arranged within the cell block such that its negative connector 14− is on the figure's right-hand side and its positive connector 14+ is on the figure's left-hand side. The next cell 4(ii) is disposed with the reversed pole direction; i.e. its positive connector 14+ is on the figure's right-hand side and its negative connector 14− is on the figure's left-hand side. The pole directions of each of the further cells 4 alternate respectively until the last (eighth) cell 4(viii). Thus, positive connectors 14+ and negative connectors 14− alternate in the stacking direction.

A pocket 16 is configured in the connector pressure plate 6. The pocket 16 is a recess in which two connection terminals 18 (18+, 18−) are arranged. The connection terminals 18 are externally accessible and form the poles of the battery 2. In particular, connection terminal 18+ forms a positive pole for battery 2 and connection terminal 18− forms a negative pole for battery 2. Further components (not depicted in greater detail) are also provided in the pocket 16 for controlling and regulating the battery 2 and the individual cells 4.

Spacers 20 are arranged between respectively consecutive connectors 14 of two cells 4. The spacers 20 exhibit either a through-connecting device 22, a unilateral contacting device 23 or no contacting device. The through-connecting devices 22 are configured so as to establish an electrical connection between the connectors 14 when connector 14 firmly abuts both sides of the spacer 20. The unilaterally contacting devices 23 are configured so as to establish an electrical connection with one of the two connectors 14 when connector 14 firmly abuts both sides of the spacer 20 so as to enable tapping of the spacer externally. When neither a through-connecting device 22 nor a unilaterally contacting device 23 is provided in a spacer 20, the connectors 14 on both sides of a spacer 20 are reliably separated from one another electrically. One can also say that a spacer 20 having a through-connecting device 22 is a through-connecting or through-connected configured spacer, a spacer 20 having a unilaterally contacting device 23 is a single-side contacted or single-side contacting configured spacer, and a spacer 20 without a contacting device 22 or 23 is a non-contact or non-contacting configured spacer.

For the purpose of length compensation, end pieces 21a, 21b are arranged on the connectors 14+, 14− of the first and last cell 4(i), 4(viii) at the outward-facing side in the stacking direction, the length of which differs from the spacers 20 and which bridge the distance between the respective connector 14 and the pressure plates 6, 8. This thereby creates a closed column of spacers 20, connectors 14 and end pieces 21a, 21b between the pressure plates 6, 8.

A pressure element 24 having a pressure-transmitting member 26 is arranged in the connector pressure plate 6 in each case such that the pressure-transmitting member projects through an opening 54 in said connector pressure plate 6. The openings 54 are each situated in the elongation of one of the columns of spacers 20, connectors 14 and end pieces 21a, 21b such that each of the pressure-transmitting members abuts one of said end pieces 21a, 21b. As soon as a pressure element 24 is actuated, it exerts pressure on the corresponding end piece 21a, 21b via the associated pressure-transmitting member 26 and thereby on the entire column of spacers 20, connectors 14 and end pieces 21a, 21b. By so doing, external axial pressure can thus be applied to the arrangement of spacers 20, end pieces 21a, 21b and connectors 14, the spacers 20 and end pieces 21a, 21b will be fixed in place, and a lasting contact ensured for the contacting devices 22, 23.

The precise structure of the pressure elements 24 and the pressure-transmitting members 26 will be discussed in greater detail in conjunction with further embodiments. The terms pressure element 24 and pressure-transmitting member 26 refer to the functions of generating force on the one hand and, on the other, transmitting said force to a column of spacers 20, connectors 14 and end pieces 21a, 21b as compressive force. The pressure element 24 and the pressure-transmitting member 26 (FIG. 1) on each side of battery 2 can be a single component and be realized for example by means of a single cheese head screw screwed into the connector pressure plate 6 and bearing therefrom against end piece 21a/21b, whereby the opening 54 is simply a tapped hole. Suitable measures will ensure that the compressive assemblage will not unintentionally loosen in operation.

Multiple cells 4 of the present embodiment are interconnected in a series connection. In detail, the first four cells 4(i) to 4(iv) form a group A and the second four cells 4(v) to 4(viii) form a group B of four cells 4, each forming a serial connection. To this end, each of the spacers 20 in group A between the positive connector 14+ of the first cell 4(i) and the negative connector 14− of the next cell 4 (ii), between the positive connector 14+ of cell 4(ii) and the negative connector 14− of the next cell 4(iii), and between the positive connector 14+ of cell 4(iii) and the negative connector 14− of the last cell 4(iv) exhibit a through-connecting device 21. Correspondingly, each of the spacers 20 in group B between the positive connector 14+ of the first cell 4(v) and the negative connector 14− of the next cell 4 (vi), between the positive connector 14+ of cell 4(vi) and the negative connector 14− of the next cell 4(vii), and between the positive connector 14+ of cell 4(vii) and the negative connector 14− of the last cell 4(viii) likewise exhibit a through-connecting device 21. All the other spacers 20 are not through-connecting.

The pole potentials of the A and B groups (series connections) of cells 4 of the battery 2 are tapped as follows. The spacer 20 between the negative connector 14− of cell 4(i) (the first cell in group A) and the positive connector 14+ of the next cell 4(ii) is provided with a unilaterally contacting device 23 contacting the negative side and connected to the negative connection terminal 18− by means of a negative pole line 28−. The spacer 20 between the negative connector 14− of cell 4(v) (the first cell in second group B) and the positive connector 14+ of the next cell 4(vi) is likewise provided with a unilaterally contacting device 23 contacting the negative side and connected to the negative connection terminal 18− by means of a negative pole line 30−. The spacer 20 between the positive connector 14+ of cell 4(iv) (the last cell of the first group A) and the negative connector 14− of the previous cell 4(iii) is provided with a unilaterally contacting device 23 contacting the positive side and connected to the positive connection terminal 18+ by means of a positive pole line 28+. The spacer 20 between the positive connector 14+ of cell 4(viii) (the last cell of the second group B) and the negative connector 14− of the previous cell 4(vii) is likewise provided with a unilaterally contacting device 23 contacting the positive side and connected to the positive connection terminal 18+ by means of a positive pole line 30+.

Any electrical interconnection of the cells 4 in battery 2 can be realized in the manner described. For example, omitting the unilaterally contacting device 23 from the spacers 20 of cells 4(iv) and 4(v) in FIG. 1 and instead using a spacer 20 likewise having a through-connecting device 22 between the positive connector 14+ of cell 4(iv) and the negative connector 14− of cell 4(v) will realize a series connection of all cells in the battery 2. In other words, alternating through-connecting and non-through-connecting spacers 20 are situated between the connectors 14 of consecutive cells 4 in order to realize a series connections of the cells 4; and where a separation in groups of cells is to be tapped, a through-connecting 22 is omitted and unilaterally contacting spacers 20, 23 are provided which are connected to the respective battery pole 18+, 18−.

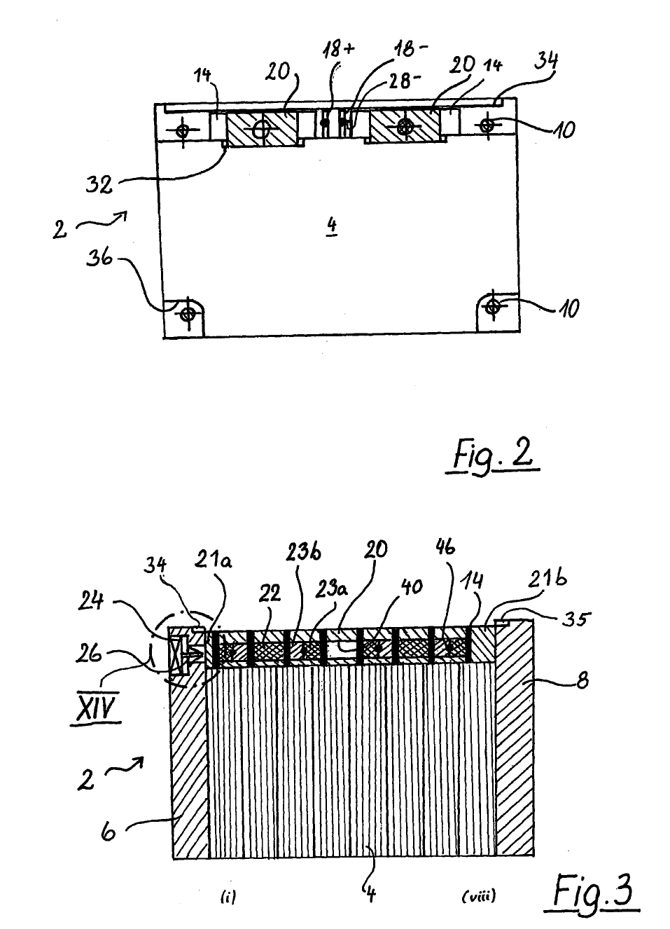

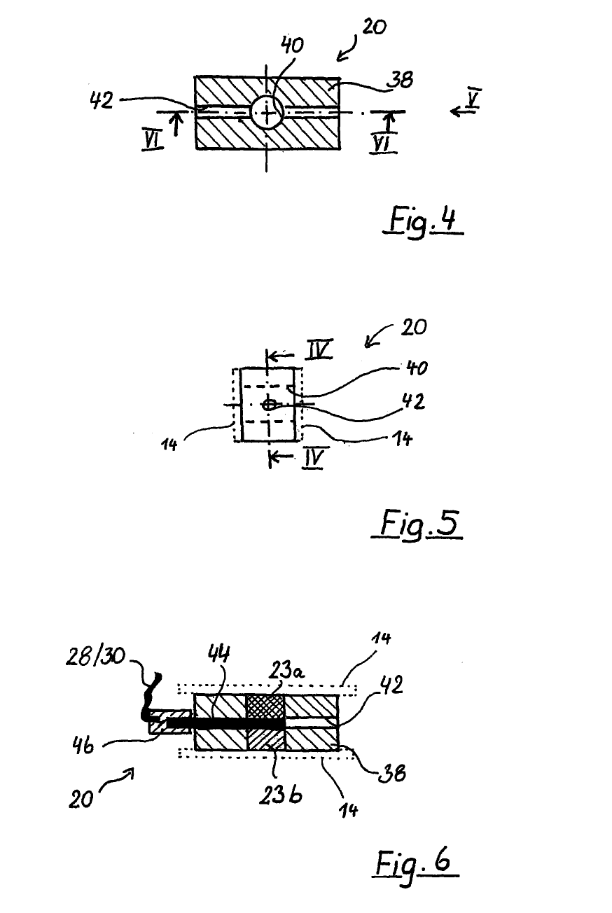

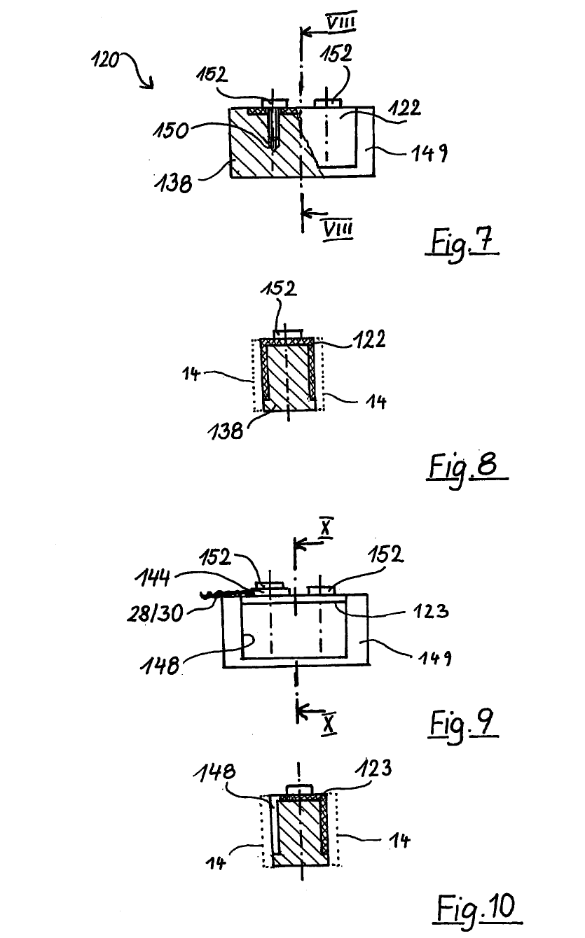

FIGS. 2 and 3 depict the structure of battery 2 according to this embodiment in greater detail. FIG. 2 is thereby a cross-sectional view, whereby the section runs along the FIG. 1 II-II line in a plane between the second and third cell 4(ii), 4(iii) and FIG. 3 is a longitudinal sectional view, wherein the section runs along the FIG. 1 line in a central plane of a sequence of connectors 14 and spacers 20, 21a, 21b.

In accordance with the FIG. 2 representation, the spacers 20 exhibit a rectangular cross section and the upper side of each cell 4 exhibits a recess 32 on the left and right half in which the spacers 20 rest. They are thereby fixed laterally and downward. The spacers are upwardly retained by a cover (not depicted in greater detail) which rests in a shoulder 34 of the connector pressure plate 6 and in a shoulder 35 of the counter-pressure plate 8. The cells 4 exhibit notches 36 (corner recesses) at the lower corners into which the block anchors 10 extend and thus enable alignment of the cells 4.

The sectional plane in FIG. 2 (line II-II from FIG. 1) intersects the spacers 20 between the second and third cell 4(ii), 4(iii). The spacers 20 are generally rectangular; their expansion in the axial direction (stacking direction of cells 4, perpendicular to the FIG. 2 graphic plane) corresponds to the space between the connectors 14. They have a central axial bore 40 which serves to receive a through-connecting device (22) or a unilaterally contacting device (23) and can otherwise remain empty.

The FIG. 3 sectional plane (line III-III in FIG. 1) intersects the spacers 20 of the compressive assemblage on the right-hand side in FIG. 1, and does so at the height of the bores 40 in said spacers 20. In accordance with the FIG. 1 circuitry, the sequence of the cells from 4(i) through to the last cell 4(viii) in these spacers 20 exhibit the sequence of: unilaterally contacting device 23, through-connecting device 22, unilaterally contacting device 23, no through-connecting device, unilaterally contacting device 23, through-connecting device 22 and unilaterally contacting device 23. The through-connecting devices 22 in this embodiment are realized by electrically conductive through-connecting bolts 22 which are received in the axial bores 40 and extend over the entire axial length of the spacers 20. The unilaterally contacting devices 23 are realized by respective electrically conductive contact bolts 23a and insulating bolts 23b which are received in the axial bores 40 and which are together as long as the entire axial length of the spacers 20. A contact pin 44 which enables outward contact is sandwiched between each of the contact bolts 23a and insulating bolts 23b. Where no contacting is to be realized, the axial bore 40 remains empty. If needed for reasons of stability, bolts made from insulating material can also be provided here as thrust bearings.

FIGS. 4 to 6 show the structure of spacer 20 and the contacting elements in greater detail. FIGS. 4 and 5 first show a spacer 2 without contacting elements.

FIG. 4 is an enlarged cross-sectional view of a spacer 20 corresponding to the line of sight of FIG. 2, thus the stacking direction of the cells 4, and wherein the sectional plane runs through the central plane of the spacer 20 as seen in the stacking direction. The spacer 20 exhibits a cuboid base body 38 made from an electrically insulating material. As noted above, an axial bore 40 extends centrally through the spacer 20. A transverse bore 42 moreover likewise runs centrally from one side of the spacer 20 to the other. The transverse bore 42 runs centrally and horizontally through the base body 38 and thereby intersects the axial bore 40. The transverse bore 42 exhibits (without limiting the generality) a smaller diameter than the axial bore 40.

FIG. 5 is a side view of the spacer 20. This view clarifies the sectional progression of FIG. 4 by means of the IV-IV line. The position of connector 14 is indicated by dotted lines.

The through-connecting bolts 22 (cf. FIG. 3) are set into axial bore 40 in through-connecting configuration.

FIG. 6 is a horizontal sectional view of the spacer 20 along the VI-VI lines from FIGS. 4 and 5 with fitted components in a unilaterally contacting configuration. Here as well, the position of connector 14 is indicated by dotted lines. In accordance with the FIG. 6 depiction, the contact pin 44 is inserted into the transverse bore 42 from one side and the contact bolt 23a and insulating bolt 23b inserted into the axial bore 40 from the opposite side, whereby they clamp the contact pin 44 between them. The contact wire presses into the insulating bolt 23b and the contact bolt 23a. A groove can also be provided in the inward-facing end faces of the insulating bolt 23b and the contact bolt 23a, its form emulating the cross section of the contact pin 44; in this case, a lug can be provided on the lateral surface for the purpose of a non-rotating fitting of bolts 23a, 23b and a groove can be provided in the axial bore 40 of the base body 38 (spacer 20) to receive the lug (not depicted in greater detail). Alternatively, the end of the contact pin 44 can be flattened. This clamping establishes a reliable electrical contact between the contact pin 44 and the contact bolt 23a.

The transverse bore 42 for receiving the contact pin 44 runs the entire width of the spacer 20 so that contact can be effected on both sides. The contact pin 44 protrudes laterally from the spacer 20 and connects to a socket 46 or the like on the pole line 28/30. Alternatively, the contact pin 44 and the socket 46 can realize a plug with a long pin.

The through-connecting bolt 22 and contact bolt 23a as well as the contact pin 44 are made from a good conductive material. Conceivable as conductive material are copper, brass, bronze or the like, although other material such as steel, aluminum, nickel silver, etc. is also conceivable. To reduce the contact resistance between contacts, the contact surfaces can be plated in gold or silver. The contact surfaces can also be abraded to further increase the contact.

The spacer 20 and the insulating bolt 23b are made from an electrically insulating material. Plastic, rubber, ceramic and the like are conceivable as insulating material.

The spacers 20 can be more flexible than the bolts 22, 23a, 23b so as to achieve a reliable pressure contact. The tolerances of the bolts 22, 23a, 23b and the spacers 20 should be harmonized such that the bolts 22, 23a, 23b are not able to retreat into the spacers 20. Two, three or more axial bores 40 with corresponding contacting elements are also conceivable.

In a modification of this embodiment, the bolts can be replaced by sleeves. Doing so can reduce the material costs and weight, which will particularly have an effect when a plurality of axial bores 40 are provided with corresponding contacting alternatives.

To the extent required for force flow reasons and to protect the material, particularly to prevent the bolts 22, 23a, 23b (or sleeves) from damaging the connector 14, counterbolts (or counter sleeves) can be provided in the non-contacting spacers 20.

FIGS. 7 to 10 show a spacer 120 with fitted components in through-connecting and unilaterally contacting configuration as the second embodiment of the present invention which is an alternative configuration of the spacer in the previous embodiment. The viewing direction of FIGS. 7 and 9 corresponds to that of FIG. 4, whereby FIG. 7 is only half-sectioned and FIG. 9 is not sectioned, and the viewing direction of FIGS. 8 and 10 corresponds to that of FIG. 5, although sectioned in the central plane (cf. the VIII-VIII line in FIG. 7, respectively X-X in FIG. 9, with associated arrows).

FIGS. 7 and 8 show the spacer 120 of this embodiment in through-connecting configuration. The spacer 120 exhibits a cuboid base body 138 made from an electrically insulating material. The upper side of the base body 138 exhibits a continuous recess 148, which continues in saddle-like manner on the front and rear side. A U-shaped contact plate 122 adapted to the recess 148 is set into the recess 148 from above such that it rests against base body 138. The contact plate 122 is secured from above by two screws 152 which are screwed into the respective tapped blind holes 150 configured in the base body 138. The U-shaped contact plate 122 creates an electrical connection from a front side to the rear side of spacer 120 and thus constitutes a through-connecting device in the sense of the invention.

FIGS. 9 and 10 show the spacer 120 in unilaterally contacting configuration. In this configuration, an L-shaped contact plate 123 is set into the recess 148 from one side, whereby the long arm abuts one of the end faces of the spacer 120 and the short arm abuts the upper side of the spacer 120. The short arm of the L-shaped contact plate 123 projects out over the center of the spacer 122, but not as far as the other end face, and is secured in accordance with the through-connecting configuration by screws 152. Its long arm abuts the connector (14, cf. FIG. 2) at that point. A contact shoe 144 at which a pole line 28/30 terminates is situated under one of the screws 152. The spacer 120 abuts the connector (14, cf. FIG. 2) at that point situated on the side opposite the long arm at the edge 149 left by the recess 148. The L-shaped contact plate 123 thus enables an insulating of consecutive connectors 14 and a receiving of the connector pole potential on the long arm side. It thus constitutes a unilaterally contacting device.

The contact plates 122, 123 are made from a good conductive material; regarding the selection, alternatives and variants of same, that stated above in conjunction with the through-connecting bolts 22 and contact bolts 23a of the first embodiment apply.

The spacer 120 of this embodiment replaces the spacer 20 in the first embodiment and is employed as same in the respectively desired configuration. In a non-contacting configuration, both sides abut the connectors 14 at the edge 149 left by the recess 148 and thus ensure the space and the clamping assemblage between successive connectors 14.

The cable shoe 144 can be configured as an eyelet ring or fork and exhibit a crimping member or a screw terminal for the pole line 28/30. The cable shoe 144 can also be replaced by a hook-shaped or loop-shaped curved end to the pole line 28/30.

FIGS. 11 to 15 show a spacer 220 with fitted components in through-connecting and unilaterally contacting configuration as a third embodiment of the present invention, which is an alternative configuration of the spacer in the previous embodiment.

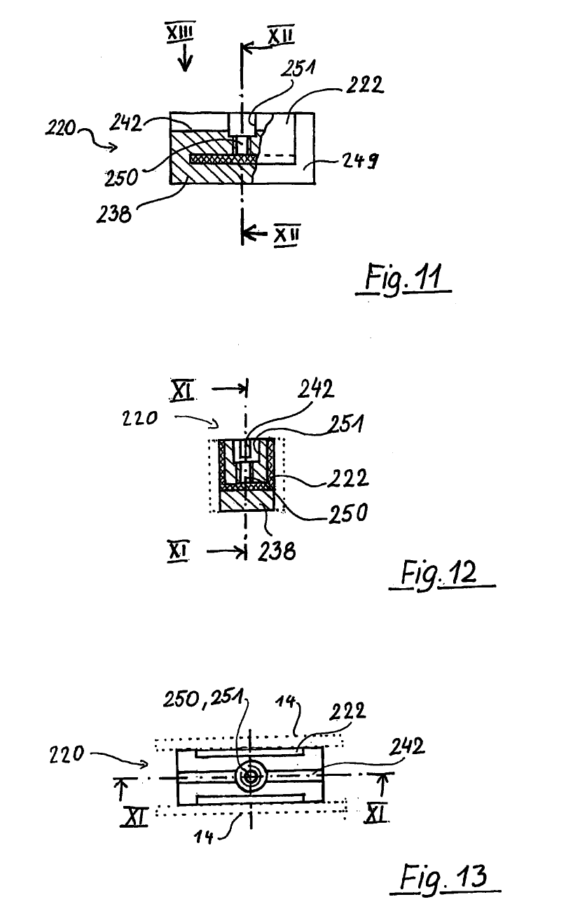

FIG. 11 is a partly cross-sectional view of the spacer 220 of this embodiment in through-connecting configuration, whereby the viewing direction and the sectional progression approximately corresponds to the situation depicted in FIG. 7. FIG. 12 is a longitudinal sectional view of the spacer 220 along the XII-XII line in FIG. 11 as seen in the direction of the arrow. FIG. 13 is a plan view of the spacer 220 (see arrow XIII in FIG. 11).

The spacer 220 exhibits a cuboid base body 238 made from an electrically insulating material. The base body 238 exhibits a horizontal continuous slot 240 between the front side and the rear side as well as a recess 248 extending upward from the respective slot 240 in the front and rear side (cf. FIG. 15). In accordance with the depictions provided in FIGS. 11 to 13, a contact plate 222 runs through the slot 240 and extends upward on both sides at the end faces of the base body 238 further into recesses 248. (Prior to assembly, the contact plate 222 is a flat or only unilaterally angled semi-finished part. During assembly, it is pushed through slot 240 and then bent upward.) It is not necessary to fix the contact plate 222 with screws. The contact plate 222 establishes an electrical connection from one end face to the other end face of the spacer 120 and constitutes a through-connecting device in the sense of the invention.

The base body 238 of the spacer 222 in this embodiment exhibits a transverse slot 242 at the upper side as well as a central tapped hole 250 extending to the slot 240 with a cylindrical countersink 251. The countersink 251 extends slightly deeper into the base body 238 than the transverse slot 242.

FIG. 14 is a cross-sectional view of the spacer 220 in unilaterally contacting configuration and corresponds to the FIG. 4 representation, and FIG. 15 is a longitudinal sectional view of the spacer 220 along the XV-XV line from FIG. 14, seen in the direction of the arrow.

An L-shaped contact plate 223 in unilaterally contacting configuration is pushed into slot 240 from one side and positioned in the recess 248, whereby the long arm in the recess 248 abuts the front or rear side of the spacer 220 and the short arm extends into the slot 240. The short arm of the L-shaped contact plate 223 projects out over the center of the spacer 122, although not to the opposite side, and is fixed via a cheese head screw 252 screwed into the tapped hole 250. The screw head is retreated into the countersink 251. The long arm of the contact plate 223 abuts the connector 14 at that point. A pole line 28/30 extends from outside the spacer 220 through the transverse slot 242 and terminates in a contact shoe 244 which is fixed by the cheese head screw 252. The spacer 220 rests against the connector 14 at that point on the side opposite the long arm by the edge 249 left by the recess 248 (cf. FIG. 11). The L-shaped contact plate 223 thus allows an insulating of successive connectors 14 and a receiving of the pole potential of the connector on the long arm side. It thus constitutes a unilaterally contacting device in the sense of the invention.

The contact plates 122, 123 are made from a good conductive material; regarding the selection, alternatives and variants of same, that stated above in conjunction with the through-connecting bolts 22 and contact bolts 23a of the first embodiment apply.

The spacer 220 of this embodiment replaces the spacer 20 or 120 in the first or second embodiment and is employed in like manner in the respectively desired configuration. In a non-contacting configuration, it abuts both sides by the edge 240 left by the recess 248 and thus ensures the space and the clamping assemblage between successive connectors 14.

The through-connecting devices can be designed in all embodiments with respect to the spacers 20, 120, 220 so as to enable the receiving of an intermediate potential at this point. In the second and third embodiment, the given screws 152, 252 with contact shoes 144, 244 can also be employed together with the through-connecting contact plates 122, 222. In the first embodiment, two contact pins 23a can be employed in place of a through-connecting bolt 22 in order to form a through-connecting device with potential receiving. A plurality of nominal voltages for battery 2, 102, 202, etc. can thus be realized in this way.

The following embodiments relate to variants in realizing the pressure assemblage.

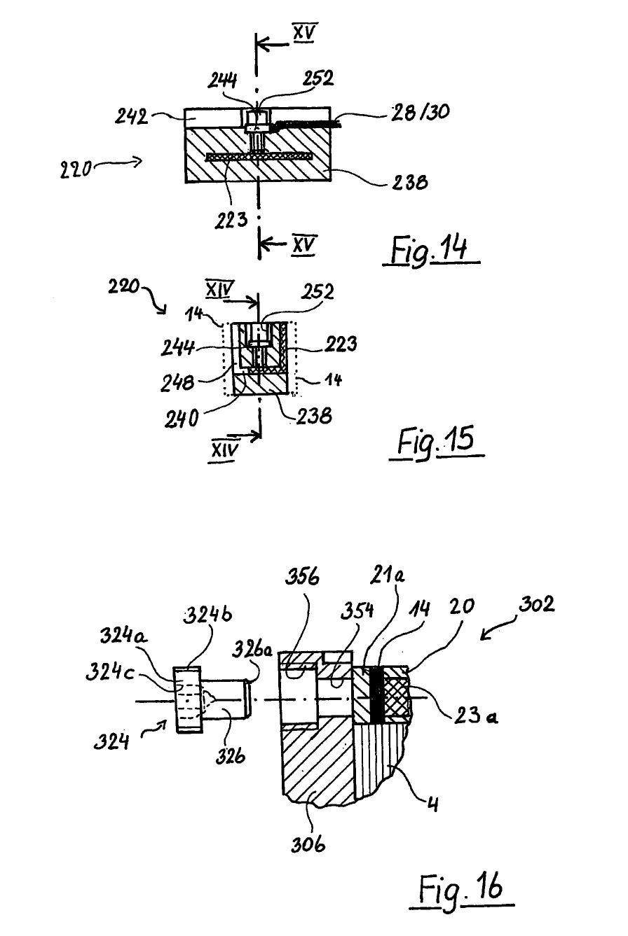

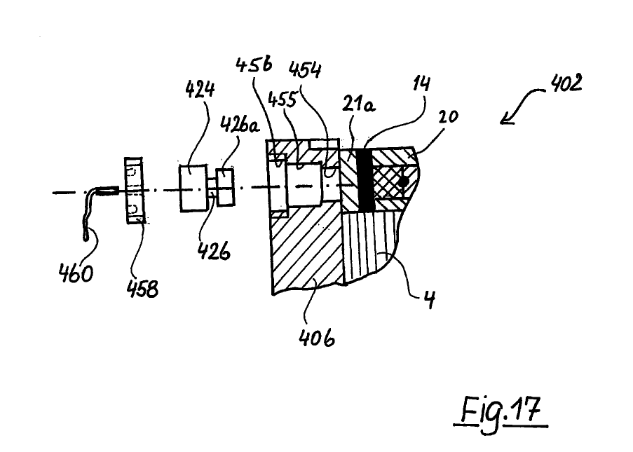

FIG. 16 shows an enlarged depiction of an area of a battery 302 as a fourth embodiment of the present invention corresponding to the XVI detail in FIG. 3.

The structure of the battery 302 of this embodiment corresponds to that of battery 2 in the first embodiment. It comprises a connector pressure plate 306 which corresponds to the connector pressure plate 6 of the first embodiment. The compressive force to create the clamping assemblage of connectors 14 and spacers 20 including end pieces 21a, 21b is generated by the connector pressure plate 306.

The connector pressure plate 306 of battery 302 of this embodiment exhibits a through-hole 325 which opens out at the height of the end piece 21a (it would be end piece 21b on the other side). The throughhole 354 exhibits an outward expansion with female threading 356. The female threading 356 is preferably a fine thread, particularly a self-locking thread. Self-locking thread here refers to a threading having a geometry designed such that a high torque is required to unscrew it out of the tightened state and automatic unscrewing is therefore unlikely.

In this embodiment, a pressure element and a pressure-transmitting member are jointly formed by a head screw 324. The head screw 324 exhibits a screw head 324a having a threaded head 324b and a hexagon socket 324c. A threaded head here refers to a male thread which is incorporated into the head of a screw and a head screw refers to a screw with a threaded head. The threaded head 324b corresponds to the female threading 356 in the connector pressure plate 306. A cylinder plunger 326 having an end heel 326a is connected to the screw head 324a, its outer diameter corresponding to the diameter of the throughhole 354. The plunger 326 and the throughhole 354 can be configured to fit yet must exhibit enough play that the screw connection will not jam.

During assembly, the plunger 326 with the heel 326a is inserted into the throughhole 354 and then the threaded head 324b screwed into the female threading 356 and tightened, whereby the tightening torque is dimensioned with respect to the compressive force needed at the front of plunger 326.

The screw head 324a of head screw 324 together with the threaded head 324b and the hexagon socket 324c thus forms a pressure element, and the plunger 326 of the head screw 324 forms a pressure-transmitting member.

A simple cheese head screw or a plurality of cheese head screws or the like can also be employed in place of the head screw 324, although utilizing a head screw facilitates forming a threading having self-locking properties due to the smaller thread pitch able to be realized. In place of or additionally to forming a self-locking thread, a countercap (not depicted in greater detail) can be affixed after assembly. A countercap here refers to a headless screw with a length shorter than its diameter; it can exhibit two eccentric bores to receive an extractor or the like.

FIG. 17 shows the same detail of a battery 402 as FIG. 16 as a fifth embodiment of the present invention.

The structure of battery 402 of this embodiment corresponds to that of battery 2 of the first embodiment. It exhibits a connector pressure plate 406 which corresponds to the connector pressure plate 6 of the first embodiment. The compressive force to create the clamping assemblage of connectors 14 and spacers 20 including end pieces 21a, 21b is generated by the connector pressure plate 406.

The connector pressure plate 406 of the battery 402 of this embodiment exhibits a throughhole 454 which opens out at the height of the end piece 21a (it would be end piece 21b on the other side). The throughhole 454 exhibits a cylindrical countersink 455 toward the outside as well as a female threading 456 (thread run-in) in its further expanded run-on area. The female threading 456 is preferably a fine thread, particularly a self-locking thread.

In this embodiment, the pressure element and the pressure-transmitting member are formed by a pressure cell 424 which drives a push rod 426 having an enlarged end plunger 426a.

During assembly, the pressure cell 424 is inserted into the countersink 454, whereby the plunger 426 projects into the throughhole 454. The countersink 455 is then closed by a cover 458. The cover 458 exhibits a male threading 458a which corresponds to the female threading 456 in the connector pressure plate 406. The cover 458 further exhibits two eccentric blind holes 458b serving to receive an extractor to tighten or loosen the cover and a central opening 458c. A connecting line 460 for the pressure cell 424 runs through the central opening 458c.

The pressure cell 424 can be designed in various ways; what is essential is for the plunger to be actuatable by a predefined, preferably controllable pressure or along a pre-determined path for the push rod 426. The drive can be electromotive, electromagnetic, piezoelectric, hydraulic or pneumatic; a memory component can also be employed as the motion element. When the pressure cell is actuated, the push rod 426 is axially extended and the plunger 426a presses on end piece 21a. This thus clamps the compressive assemblage of connectors 14, spacers 20 and end pieces 21a, 21b and reliably pressures the contacts. It is particularly advantageous for the pressure cell 424 to be designed such that the push rod locks in the extended state.

The pressure cell 424 (with cover 458 as a thrust bearing) forms a pressure element and the push rod 426 together with the plunger 426a forms a pressure-transmitting member. Instead of using cover 460, one modification of this embodiment also provides for the pressure cell 424 itself to be able to be screwed in, the female threading 456 would then also be longer and the countersink 455 could potentially be omitted.

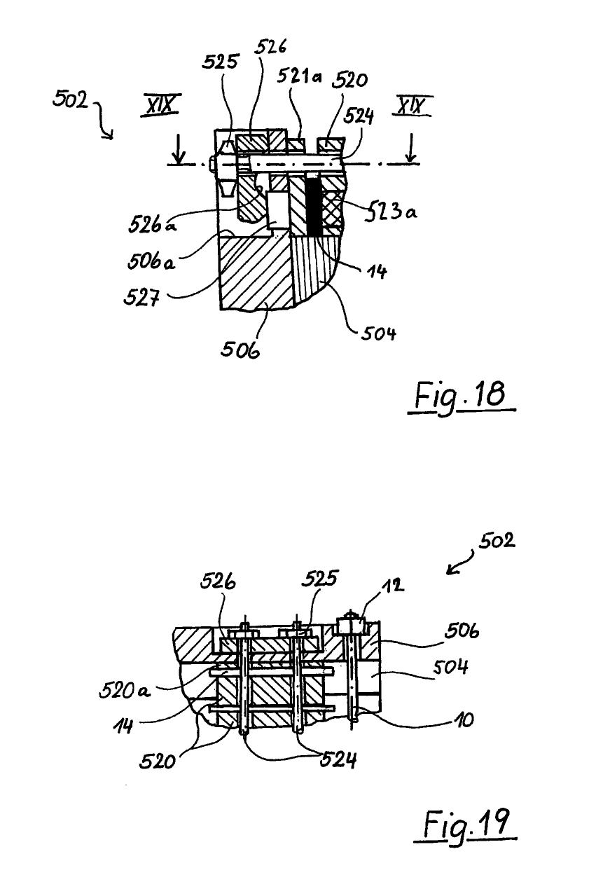

FIGS. 18 to 21 show details and full views of a battery 502 having a further pressure-introducing concept as a sixth embodiment of the present invention.

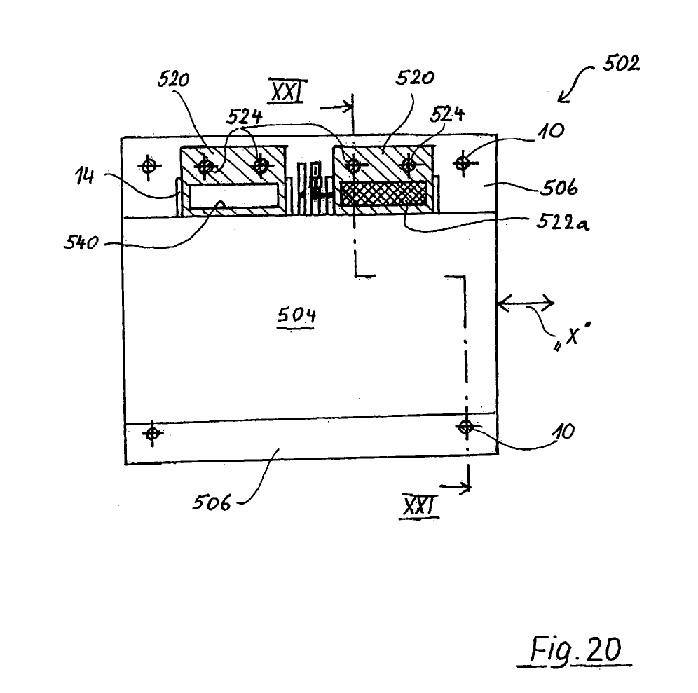

FIG. 18 shows the same detail for the battery 502 of this embodiment as FIG. 16 or 17. FIG. 19 shows the same area in a horizontal section, sectioned along the XIX-XIX line from FIG. 18. FIG. 20 is a cross-sectional view of the battery 502 between two cells 4; the view corresponds to FIG. 2. FIG. 21 is a longitudinal sectional view; same approximately corresponding to FIG. 3.

The fundamental structure of battery 502 of this embodiment corresponds to that of battery 2 of the first embodiment. Pressure plates 506, 508 correspond to the pressure plates 6, 8 of the first embodiment. The spacers 520 and end pieces 521a, 521b correspond to the spacers 20 and end pieces 21a, 21b of the first embodiment. Instead of axial bores 40 as in the spacers 20 of the first embodiment, the spacers 520 of this embodiment exhibit rectangular shafts in which cuboid or bar-shaped inserts 522, 523a, 523b (corresponds to the through-connecting bolts 22, contact bolts 23a and insulating bolts 23b of the first embodiment) are inserted. The compressive force to create the clamping assemblage of connectors and spacers is introduced by the connector pressure plate 506.

Pockets 506a are configured in the connector pressure plate 506 which serve to receive the pressure elements and the pressure-transmitting members. Spacers 520, 521a, 521b extend higher than connector 14 in this embodiment and exhibit, additionally to the shafts 540 serving to receive contacting elements 522, 523a, 523b, further axial bores above the connector 14 plane.

Two tension rods 524 extend through the respective additional axial bores in spacers 520, 521a, 521b above the connector 14 of the cells 4 of the battery 502. The tension rods 524 are supported by their heads in correspondingly dimensioned recesses 508a of the counter-pressure plate 508 and extend into the pocket 506a in the connector pressure plate 506 where they terminate in nuts 525. The tension rods 524 and nuts 525 form a pressure element to tension the spacers 520 and end pieces 521a, 521b in this embodiment. It is noted that the tension rods 524 are provided additionally to the block anchors 10. To differentiate from the function of the block anchors 10, the tension rods 524 will also be referred to as “contact anchors” 524 in the following.

A pressure-transmitting member is formed by a bridge 526 and pressure bolts 527. The pressure bolts 527 are seated in throughholes of the connector pressure plate 506 at the height of the connector 14 shafts 540 and meet the end pieces 521a (or 521b on the other side). The bridge 526 is a bar-shaped component exhibiting a channel 526a extending in the transverse direction to the battery 502 facing the battery interior. Channel 526a forms two support lines, from which one is situated above the contact anchors 524 on the wall of pocket 506a and the other at the height of the pressure bolt 527. The contact anchors 524 extend below the upper support line through the bridge 526 and the nuts 525 press on the bridge 526 from the outside such that the direction of force runs between the two support lines of the bridge 526. The bridge 526 hence forms a lever which transmits the tractive force of the contact anchors 524 to the pressure bolts 527 and thus reliably tensions the assemblage of connectors 14 and spacers 520, 521a, 521b.

According to the FIG. 20 representation, the cells 4 exhibit no recesses (cf. 32 in FIG. 2) on the upper side to receive the spacers 520. The spacers 520, 521a, 521b are held in position by the contact anchors 524 such that the cited recesses are unnecessary.

Nor do the cells exhibits notches on the lower side. Instead, the cells 4 are situated on the lower block anchors 10. The block anchors 10 are long cheese head screws, the heads of which are seated in correspondingly dimensioned countersinks 506b of the connector pressure plate 506 and are screwed into tapped holes 508b in the counter-pressure plate 508 (or vice-versa). The tension rods 524 are non-rotatably mounted in the counter plate by means of e.g. square or greater-ended tooth tips and are screwed to the bridge 526 on the side of the connector pressure plate 506. All the screw connections lie above or below the contours of the cells 4 along with the connector 14. The pole lines 28/30 are also situated above the connector plane. When all the tension rods (block anchor 10 and contact anchor 524) are loosened, individual cells 4 can be pulled out of the cell block laterally and replaced (the “X” double arrow in FIG. 20). The spacers cannot fall out since they are held by the contact anchors.

While the contact anchors 524 are independent of the block anchors 10, they can support their action. In other words, by tightening contact anchors 524, additional pressure is exerted on the pressure plates 506, 508 which contributes to clamping the cell block. Since, however, the contact anchors 524 are mounted at a later time, the tractive force of block anchor 10 needs to suffice to support the cell block. In order to prevent continuously unilateral stress, the clamping torque of the lower block anchor 10 can be increased after or shortly before mounting the contact anchor 524. Under certain conditions, the upper block anchor 10 can also be omitted.

Although not depicted in any greater detail, suitable measures can ensure that the assemblage only needs to start from one of the pressure plates 506, 508. For example, the tension rod 510 can likewise be screwed into female threading in the counter-pressure plate 508 and their heads can be seated directly on the bridge 526 where a suitable tool can tighten them.

In a modification of this embodiment, the contact anchor can be diminished to substantially tensionless guide rods for the spacers 520, 521a, 521b while the contacting ensues separate therefrom according to the principles of FIGS. 1 to 17. In this case, bridges 526 can be omitted.

In the above embodiment, the contact anchor runs through the throughholes in the pressure plates 506, 508 and are thus radially supported. In a further modification, the pressure plates 506, 508 exhibit slots running from above in place of the cited through-holes, through which the contact anchor 524 can be removed upwardly, this occurring together with the spacers 520 and end pieces 521a, 521b arranged thereon.

In a further modification, the spacers 520 and end pieces 521a, 521b exhibit protrusions in the progressing area of the contact anchor 524 such that the spacers 520 and end pieces 521a, 521b are in contact above the plane of the connector 14. Doing so creates an axially stable assemblage of spacers 520 and end pieces 521a, 521b and can prevent an unwanted axial slackening and displacing of the spacers 520 or the end pieces 521a, 521b when individual cells 4 are removed. Doing so also creates an effective thrust bearing to the contact pressure of the bridge 526 over the plane of the contact anchor 524 and can prevent unwanted deformations of the wall of the pocket 506a.

In a further modification of this embodiment, the block anchor can be laterally positioned outside of the cells. In this case, cells can be pulled out of the cell block and replaced from below.

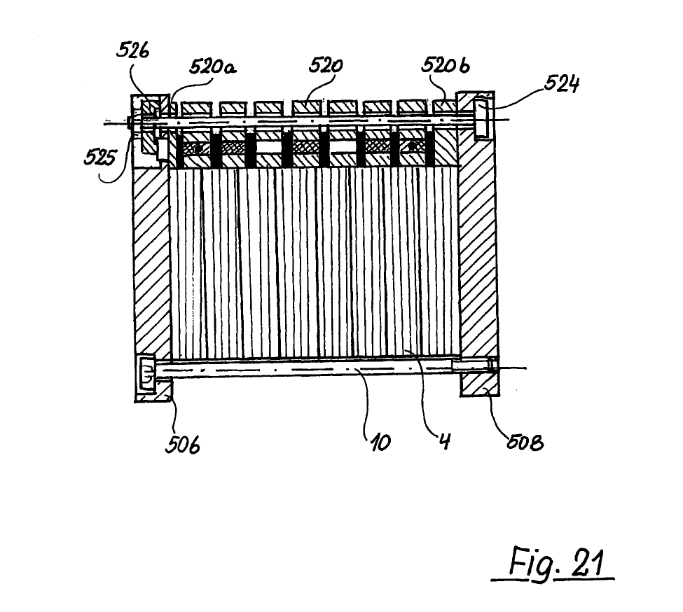

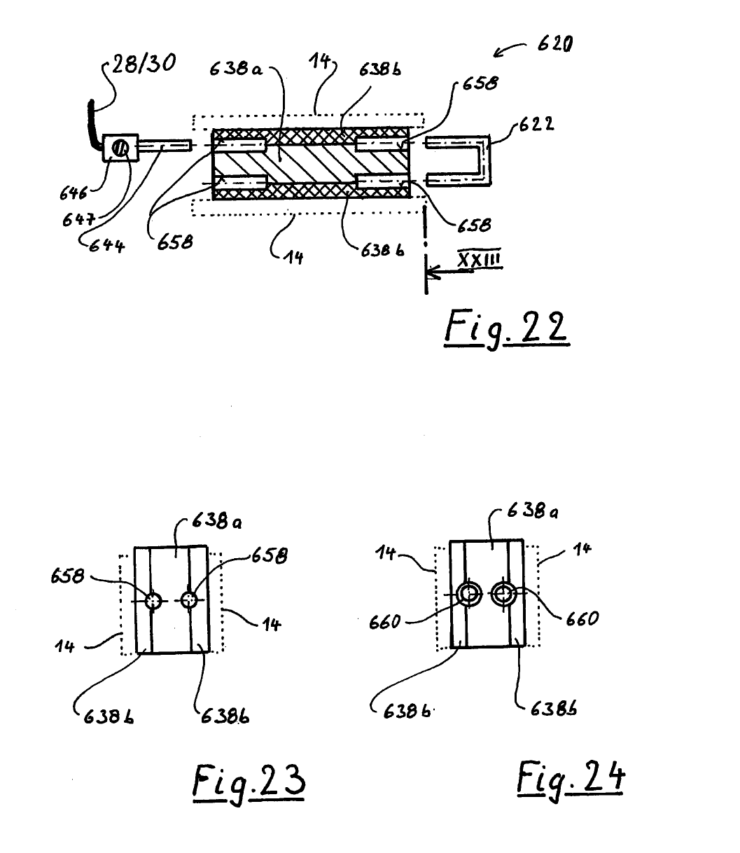

FIGS. 22 and 23 show a spacer 620 as a further embodiment of the invention. FIG. 22 is thereby a horizontal sectional view of the spacer 620 and FIG. 23 is a side view in the viewing direction of the XIII arrow in FIG. 22.

The spacer 620 in this embodiment exhibits an insulating layer 638a sandwiched between two conductive layers 638b. This layer structure can be termed the base body of the spacer 620. The conductive layers 638b are thin compared to the insulating layer 638a. Seen in the stacking direction of the battery 2, the conductive layers 638b form the front and rear side of the spacer 620 which are in contact with the electrical connectors of the battery cells (dashed lines are used to indicate the electrical connectors 14 in the figure).

Two blind holes 658 are configured in each of the lateral flanks of the spacer 620 such that they lie partly in the insulating layer 638a and partly in one of the conductive layers 638b. The blind holes 658 lie behind one another on a horizontal plane in the stacking direction.

Thus, one blind hole 658 intersects one of the conductive layers 638b on each flank of the spacer 620 and the other blind hole 658 intersects the other conductive layer 638b.

The conductive layers 638b have no electrically conductive connection to one another. Hence, the spacer 620 can be used as a non-contacting spacer 620 as described above.

A conducting bridge 622 is incorporated into the blind holes 658 in a flank of the spacer 620 to establish an electrically conductive connection between the conductive layers 638b. With the conducting bridge 622, the spacer 620 can be used as a through-connecting spacer 620. In particular, the conductive layers 638b and the conducting bridge 622 form a through-connecting device in the sense of the invention.

A connector with a pin 644 and a connector housing 646 is configured so as to fit into the blind hole 658 in a flank of the spacer 620. A locking screw 647 able to clamp a pole line 28/30 of the battery 2 is provided in the connector housing 646. Inserting the connector 644, 646 into one of the blind holes 658 (without conducting bridge 622) configures the spacer 620 as unilaterally contacting since the pin 644 creates an electrically conductive connection from one of the conductive layers 638b externally of the spacer 620. Specifically, one of the conductive layers 638b and the connector 644, 646 forms a unilaterally contacting device in the sense of the invention.

The spacer 620 of this embodiment is designed so that both a conducting bridge 622 as well as a connector 644, 646 can also be used and that a potential prevailing at this point can thus also be tapped in the through-connecting configuration of the spacer 620.

A plurality of blind hole 658 pairs can also be arranged on at least one flank of the spacer 620 of this embodiment in order to realize a larger conductor cross section by utilizing a plurality of conducting bridges 622.

The blind holes 658 can be of the same or different diameter on the two flanks of the spacer 620.

The insulating layer 638a is a central section in the sense of the invention and the conductive layers 638b are outer sections in the sense of the invention. The blind holes 658 and recesses 662 are recesses in the sense of the invention.

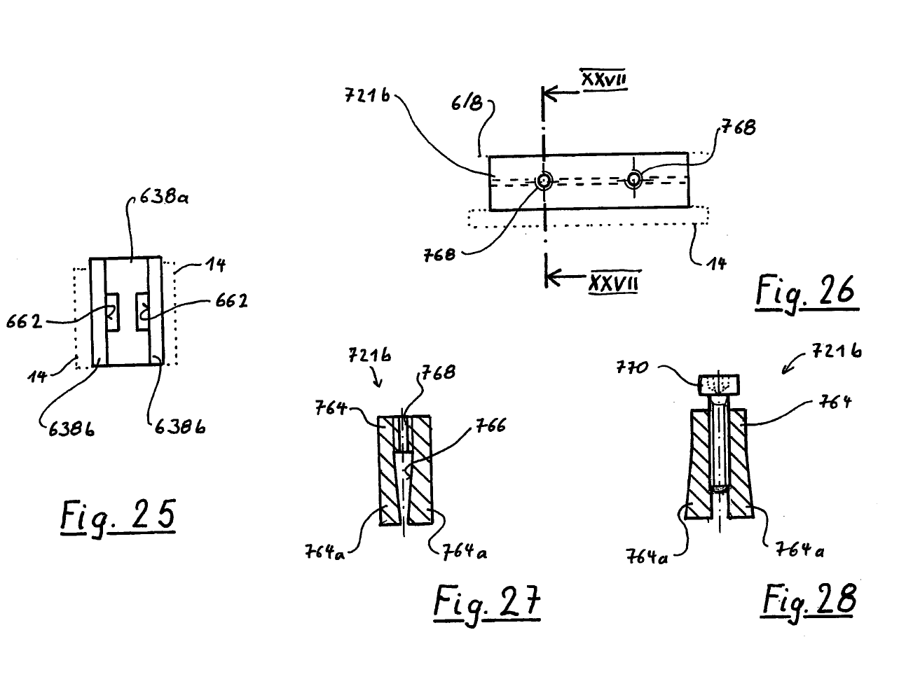

FIG. 24 corresponds to the FIG. 23 view and shows a modification of the spacer 620 of this embodiment. Sockets 662 are thereby fixedly arranged in place of the blind holes (658, cf. FIGS. 22, 23). The inner diameter of the sockets 662 is adapted to the outer diameter of the connector pins. Utilizing the sockets 662 contributes to improving a conductive connection between the conductive layers 638b and the connector pins 644.

FIG. 25 corresponds to the FIG. 23 view and shows a further modification of the spacer 620 of this embodiment. Here, instead of the blind holes (658, cf. FIGS. 22, 23), recesses 662 of rectangular cross section are respectively configured in the flanks of the spacer 620 in the area of the insulating layer 638a facing a conductive layer 638b. The recesses 662 can be configured as pockets or as continuous grooves. This embodiment makes use of connectors or bridges of rectangular conductor cross section (not depicted in greater detail) which contact the respective conductive layer 638b when inserted into the recesses 662.

In further modifications of the embodiment, bores and/or recesses can be arranged on just one side to establish contact between the conductive layers 638b.

In further modifications of the embodiment, bores and/or recesses can be arranged additionally or solely on the upper side of the spacer 620 to establish contact between the conductive layers 638b.

FIGS. 26 to 28 depict a further possibility for introducing pressure in the succession of electrical connectors and spacers as a further embodiment of the invention. FIG. 26 thereby shows an end piece 721b in a plan view, FIG. 27 the end piece 721b in a longitudinal section along the FIG. 26 XXVII-XXVII line, and FIG. 28 the end piece 721b in a view corresponding to FIG. 27 in an actuated state.

The end piece 721b is arranged between an electrical connector 14 and the connector pressure plate 6 or the counter-pressure plate 8 of the battery. In accordance with the FIG. 26 representation, the end piece 721b exhibits two tapped holes 768 at its upper side.

FIG. 27 shows a longitudinal section of the end piece 721b (a longitudinal section in the context of the present application refers to a section in a vertical plane running parallel to the battery's stacking direction) through one of the tapped holes 768. The end piece 721b is formed by a cuboid base body 764. A groove 766 runs transversely from its lower side from one flank to the other flank. The groove 766 exhibits a cross-sectional shape which expands from a narrow slot on the lower side inward of the base body 768 to a width which corresponds to the nominal diameter of the tapped hole 768. The groove 766 terminates in the upper half of the end piece 721b. The groove 766 defines two arms 764a in the base body 764 which protrude downward from an upper part of said base body 764.

FIG. 28 illustrates how the arms 764a of the end piece 721b are displaced and thereby pressed apart by the cheese head screws 770 being screwed into the tapped holes 768. When incorporated into a battery (2, cf. FIGS. 1-3, etc.), the arms 764a press on the arrangement of electrical connectors and spacers in the axial direction and thus create a reliable clamped assemblage. The pressure can be readily set by the screw-in depth of the cheese head screws 770.

More than two tapped holes 768 can be provided; where applicable, only one tapped hole 768 will also suffice.

The arms 764a can be of slightly convex outer rounding (i.e. the front and rear of end piece 721a) in order to optimize the introduction of pressure.

The functional and structural principle of the present invention can also be applied to cells having opposing connectors on the lateral flanks with only few adjustments.

In further developments of the present invention, all the tension rods (contact anchors as well as block anchors) and/or other tensioning and clamping elements can be loosened and tightened electromotively, piezoelectrically, hydraulically, pneumatically, or by means of shape memory elements or the like by remote control. A concerted actuating of the tension rods or other tensioning and clamping elements by means of levers, racks and joints, toggle or worm drives is likewise conceivable.

An automatic shutdown of the cell block upon malfunction (overheating, overloads, brown-outs, etc.) as well as a manual or automatic replacing of cells upon failure can also be optionally provided.

In some of the above-described embodiments, the spacers only exhibit one axial bore 40 at approximately their center. It is also possible to change the position of the bore 40 (and thus the contacting position) further outward or inward or to provide a plurality of bores (and thus a plurality of contacting points) or, as in the fourth embodiment, provide shafts 540 and contact elements of rectangular cross section.

The configuration of the connector 14 of cells 4 contributes to the invention to the extent that they protrude from the cell with surfaces substantially parallel to one another, that the main surfaces of the connector are aligned substantially perpendicular to the stacking direction, that the connectors of a cell do not cover each another at least partly (here: entirely) in the stacking direction, and that each connector of a cell at least partly (here: entirely) covers a connector of a subsequent cell in the stacking direction. In a modification of the above-described fundamental embodiment, the connectors 14 of a cell 4 can also be arranged next to one another in one plane. In a further modification, they can also, provided they are arranged offset in the thickness direction, partly cover each other. Should the connectors 14+, 14− of a cell 4 be covered as seen from the front, bores or cutouts can be provided in the connectors 14 which align in the assembled cell block and through which the positive pole lines 28/30 can be guided. The pole lines 28 can be insulated independently thereof to prevent short circuits.

In a further modification, in order to thwart an erroneous pole arrangement, the strict symmetrical arrangement to the connectors 14 can be violated in at least one regard: e.g. one of the electrical connectors 14+, 14− can be wider than the other. What is essential here is that the connectors of a cell do not overlap each another at least partly in the stacking direction so that the spacers 20 can be arranged between the connectors 14 of consecutive cells 4.

The configuration of the spacers 20 and the contacting devices 22, 23 allow further variants. What is essential is that the spacers 22 are arranged between the connectors 14, comprise contacting devices 22, 23 and are clamped between the connectors 14 by external pressure, whereby contact is at the same time ensured there where intended. The spacers can for example be made completely of insulating or conducting material; a unilateral contacting (tapping of pole potential) can then occur for example by means of insulating spacers and lead lugs clamped therebetween.

In the above-described embodiments, a battery 2 is formed by eight storage cells 4 connected in series. It goes without saying that the number of cells 4 in the battery and their interconnections can be of any reasonable configuration based on the specifications governing battery voltage and capacity.

In the above-described embodiments, the storage cells 4 are assembled into the battery block with respectively alternating pole directions. A further modification can provide for not alternating the pole direction of the cells after each cell but rather pairs or larger groups of consecutive cells 4 can be set with the same respective pole direction. The pairs or groups can then form respective parallel connections and consecutive pairs or groups can be series connected. To this end, the connectors within a pair or group having the same polarity set on the same consecutive side can be electrically connected by means of contact elements (contact sleeves, shoes or bridges). A contact element is employed on one side of a junction between a pair or a group of the next pair or group and an insulating element on the other side. If particularly high capacity is desired for a cell block and the cell voltage of one individual cell suffices, all the cells in the block can thus also be disposed with the same polarity and the connectors on each side respectively connected together by means of contact elements.

The invention was described above on the basis of preferred embodiments and various modifications thereof. It goes without saying that while concrete embodiments of the claimed invention are illustrative and exemplifying, they are not limiting. The invention itself is solely defined and limited by the most general understanding of the claims. It likewise goes without saying that the features of different embodiments and/or modifications can be combined and/or interchanged so as to capitalize on the respective advantages.

Within the meaning of the invention, the storage cells 4 are electrical energy cells, the batteries 2, 102, 202, 302 are electrical energy units, the stack of cells 4 is a cell block, the connection terminals 18+, 18− are connecting poles, and positive and negative are polarities.

### LIST OF REFERENCE NUMERALS

2 battery
4 storage cell
6 connector pressure plate
8 counter-pressure plate
10 tension rod
12 nut
14+, 14− positive, negative connector
16 clamping pocket
18+, 18− positive, negative connection terminal
20 spacer
21a, 21b end piece
22 through-connecting device (bolt)
23 unilaterally contacting device
23a contact bolt
23b insulating bolt
24 pressure element
26 pressure-transmitting member
28+, 28− positive, negative pole line (first group A)
30+, 30− positive, negative pole line (second group B)
32 recess
34, 35 shoulder
36 notch
38 base body
40 axial bore
42 transverse bore
44 connecting pin
46 socket
54 guide opening
120 spacer (second embodiment)
122 contact plate (bilateral)
123 contact plate (unilateral)
138 base body
144 cable shoe
148 recess
149 edge
150 tapped blind hole
152 screw
220 spacer (third embodiment)
222 contact plate (bilateral)
223 contact plate (unilateral)
238 base body
240 slot
42 transverse groove
44 cable shoe
48 recess
249 edge
   250 tapped hole
251 cylinder countersink
252 screw
302 battery (fourth embodiment)
306 front plate
324 pressure bolt
324a threaded screw head
324b male threading
324c hexagon socket
326 (locating) lug
326a heel
354 (locating) bore
356 threaded countersink
402 battery (fifth embodiment)
406 front plate
424 pressure element
426 pressure rod
426a end plate
454 throughhole
455 countersink
456 thread run-in
458 cover
458a male threading
458b blind hole
458c throughhole
460 supply line
502 battery (sixth embodiment)
504 battery cells
506 connector pressure plate
506a pocket
506b countersink
508 counter-pressure plate
508a recess
508b tapped hole
520 spacer
521a, 521b end piece
522 bar
523a contacting bar
523b insulating bar
524 contact anchor
525 nut
526 bridge
527 pressure bolt
540 shaft
620 spacer (seventh embodiment)
622 conducting bridge
638a insulating layer
638b conductive layer
644 connector pin
646 connector housing
647 locking screw
658 blind hole
660 socket (modification)
662 recess (modification)
721b end piece (eighth embodiment)
764 base body
764a arm
766 groove
768 tapped hole
770 cheese head screw
i, ii, viii numerals identifying cells 4
A, B groups of cells 4

It is expressly emphasized that the above list of reference numerals is an integral part of the description.

1. An electrical energy unit comprising a plurality of electrical energy cells stacked in a stacking direction to form a cell block and interconnected within the cell block in parallel and/or in series connection, wherein the electrical energy cells comprise planar connectors protruding from the cell with substantially parallel surfaces to one another, wherein the main surfaces of the connectors are oriented substantially perpendicular to the stacking direction, wherein the connectors of a cell do not cover each another at least partly as viewed in the stacking direction, wherein each connector of a cell at least partly covers a respective connector of a subsequent cell in the stacking direction as viewed in said stacking direction, characterized in that the electrical connection between opposite connectors is produced by through-connecting spacers or non-through-connecting spacers disposed in the interspaces between connectors of consecutive cells, wherein the spacers are clamped between the connectors by a compressive force from a clamping device, wherein the clamping device is arranged completely externally of the connectors.

2. The electrical energy unit according to claim 1, characterized in that the clamping device comprises force-generating elements to generate a force, wherein the force-generating elements act directly on the arrangement of connectors and spacers in the stacking direction.

3. The electrical energy unit according to claim 1, characterized in that the clamping device comprises force-generating elements to generate a force and force-transmitting elements, wherein the force-transmitting elements transmit the force exerted on the arrangement of connectors and spacers by the force-generating elements.

4. The electrical energy unit according to claim 1, characterized in that the clamping device comprises tension rods which extend past the connectors over the length of the stack and clamping elements, wherein the clamping elements transmit a force exerted by the tension rods to a plane traversing the spacers.

5. The electrical energy unit according to claim 4, characterized in that the tension rods run through bores in the spacers.

6. The electrical energy unit according to claim 1, characterized in that the clamping device comprises at least one actuator, wherein an external actuating force of the actuator acts on the arrangement of connectors and spacers in the stacking direction either directly or via levers, joints or the like.

7. The electrical energy unit according to claim 6, characterized in that the actuator can be controlled mechanically, particularly manually, or electromotively, electromagnetically, hydraulically, pneumatically or piezoelectrically.

8. The electrical energy unit according to any one of the preceding claims, characterized in that a spacer abutting a connector exhibits a tapping device which establishes an electrical connection with the connector.

9. The electrical energy unit according to claim 8, characterized in that the tapping device is provided on a unilaterally contacting spacer which is a non-through-connecting spacer.

10. The electrical energy unit according to any one of the preceding claims, characterized in that a first connecting pole and a second connecting pole of the electrical energy unit are provided, wherein the first connecting pole is connected to a connector of a first polarity of the first cell in the cell block, and wherein the second connecting pole is connected to a connector of a second polarity of the last cell in the cell block.

11. The electrical energy unit according to claim 8, characterized in that the cells are arranged in the stacking direction with alternating pole directions.

12. The electrical energy unit according to any one of claims 8 to 10, characterized in that the cell block of the plurality of cells is clamped between two pressure plates, wherein the pressure plates are tensioned, preferably by means of tension rods.

13. The electrical energy unit according to any one of the preceding claims, characterized in that the electrical energy cells are galvanic cells, preferably secondary cells, wherein an electromagnetically active material of the cells in particular comprises lithium or a lithium compound.

14. A spacer for use between connectors of two consecutive electrical energy cells in a cell stack, wherein the spacer is made from an electrically non-conductive material and exhibits two parallel end faces at a distance of the interspace between the connectors, at least one first receiving device for receiving a contact element for the electrical contact on at least one of the end faces, and a second receiving device for receiving a connecting element to establish an electrical connection with the contact element of another face of the spacer other than the end face.

15. The spacer for use between connectors of two consecutive electrical energy cells in a cell stack, wherein the spacer exhibits a center section made of an electrically non-conductive material as well as two outer sections made from an electrically conductive material bordering the center section in a parallel, sandwiching manner, wherein the outer sections define the spacer end faces, wherein the distance between the end faces corresponds to the distance of an interspace between connectors of two consecutive electrical energy cells in the cell stack, wherein at least two recesses are provided in other external surface areas than the two end faces, wherein one of said recesses exhibits a connection to one of the outer sections but no connection to the other of the outer sections, and wherein the other recesses exhibit a connection to the other of the outer sections but no connection to said one of the outer sections, wherein the recesses are configured elsewhere than the end faces.
